(19) United States
(12) Patent Application Publication
(10) Pub. No.: US 2010/0241628 A1
(43) Pub. Date: Sep. 23, 2010

(54) User generated image facades on virtual 3D structures displays on mobile platforms for mobile users

(76) Inventor: Isaac Levanon, Raanana (IL)

Correspondence Address: Isaac Levanon, P.O. Box 358, Raanana, 43107, IL

(21) Appl. No.: 12/592,310

(22) Filed: Nov. 24, 2009

Related U.S. Application Data
(60) Provisional application No. 61/199,915, filed on Nov. 24, 2008.

(51) Int. Cl. G06F 17/30

(52) U.S. Cl. 707/741; 707/802; 707/E17.044; 707/E17.002

(57) ABSTRACT

The present invention relates to the creation of user's generated elements for 3D virtual reality scenery for navigating users on computing devices. The present invention allows for an efficient gathering of content such as images of structures such as buildings external and/or internal facades by the users computing devices and to provide a means to individuals and/or entities to deliver possibly timely actual image and/or images of structures such as buildings external and/or internal facades to end users who are traveling with computing devices by vehicle and/or by foot in an urban and/or suburban region and/or inside structures such as buildings private and/or public areas such as for example office building, shopping malls and/or sport areas.

This application claims the benefit of U.S. Provisional Application No. 61/199,916 filed Nov. 24, 2008, and claims the benefit of U.S. Provisional Application No. 60/839,942 filed Aug. 25, 2006, now expired. The entire disclosures of these applications are incorporated herein by reference.

### FIELD OF THE INVENTION

The present invention may be directed to facilitating dynamic advertising for users of mobile computing platforms by providing for example virtual scenery that may include outdoors and/or indoors 3D structures such as buildings database organization.

### BACKGROUND

Modern commuters may use different types of mobile/portable computing platforms to obtain various navigation services. For example Mobile/portable computing platforms that may provide navigation features and/or services may include for example dedicated computing devices and/or general purpose computing devices. Dedicated computing devices for example, may include in-vehicle navigation systems, personal (i.e., portable and/or hand-held) navigation devises (PNDs) and/or personal travel assistance (PTA) systems. General-purpose computing devices for example may include portable personal computers such as notebook and/or netbook computers, and/or personal digital assistants (PDAs) and/or mobile handsets such as Cellphones and/or SmartPhones. General purpose computing devices may provide navigation features and/or services for example by operating application software and/or by using geographic data. Mobile and/or portable computing platforms that may provide navigation features and/or services may include for example standalone systems that may have geographic data and/or navigation application software that may be installed locally; client devices that may access geographic data and/or navigation application software that may be located at a remote location; and/or hybrid devices that may have some geographic data and/or navigation application software that may be installed locally and/or may obtain and/or use geographic data and/or navigation application software that may be located at a remote location.

Some of the various geographically-related features and/or services provided by the different types of mobile and/or portable computing platforms may include for example route calculation and/or guidance. For example, some mobile/portable computing platforms may provide users with a route and/or routes for travel for example between the present and/or changing location and singular and/or plural target destinations that may be a singular and/or polarity of location of a person, and/or an item within the geographic region and/or within structure such as a building for example shopping mall, office building and/or sport arena.

Using the user's for example conscious input, and/or automatic input and/or the combination thereof, regarding the user's physical location, such as for example via a possible builtin and/or external locator such as for example GPS, AGPS, Galileo, GLONASS and/or triangulation, wireless and/or cellular, a possible compass and/or other locator method and/or the combination thereof, a navigation application program for example that may be running on and/or accessible by a mobile or portable computing platform system may examines various paths between the starting point and target destination and/or destinations to determine for example the optimal, shortest, driving and/or walking route of travel there between and/or the combination thereof. The user of the mobile and/or portable computing platform may then be provided with information about possible route and/or routes for example in the form of instructions and/or maneuvers and/or the combination thereof that may identify the instructions and/or maneuvers and/or the combination thereof that may be required and/or recommended to be taken by the end user to travel from the starting and/or other location to the destination location and/or locations.

Another possible geographically-related feature may be provided by some mobile/portable computing platforms may be a business or person locating service, commonly referred to as electronic yellow and/or white pages and/or point of interest (POI). Such a service may identify addresses of individuals or businesses. These services may also identify for a user for example which businesses of a certain type (e.g., Chinese restaurants) may be located within for example a given range (e.g., 3 miles) of a given location.

Another geographically-related feature may be provided by some mobile and/or portable computing platforms such as information to end user based upon for example the end user location. Some types of information, such as advertising, may provide directed information based upon for example the user's location, may deliver advertising to end users who may be traveling in a geographic region and/or in a structure such as a building for example shopping mall and/or sport arena.

A further geographically-related feature may be provided by mobile and/or portable computing platforms such as details concerning 3D structures such as for example buildings for outdoor urban and/or rural navigation and/or indoor navigation. Such navigation may attempts to provide for example a virtual representation of the real world by for example structural such as building shape, height, external and/or internal facade textures and/or images into for example 3D models. With a viewer 3D and/or others, the outdoor urban and/or rural and/or indoor scene may be rendered for example on a computing device desktop and/or mobile device that may be displayed on such device screen. New advances in technology in both hardware and/or software may present outdoor-view, bird-eye-view, street-view and/or indoor-view and/or the combination thereof, where the virtual 3D structures such as buildings may become part of advance outdoor urban and/or suburban and/or indoor navigation system and/or service that could be found in most mobile and/or portable devices at present and/or in the future.

Although present mobile/portable computing platforms that provide geographically-related features and/or services may be able to provide possibly useful advantages, there may be room for further improvement. Virtual 3D structures such as building representation may be done by using random generated and/or specific generated graphics and/or in some cases for example the corresponding image of the building external and/or internal facades may provide for example more realistic view of the real world as may be presented in the virtual world.

Location based roadside and/or indoor billboards may distract and/or confuse the user and/or may obscure location indication such as for example GPS location tracking, route, street name and/or other information and/or may not be dynamic to address for example the users location, preferences and/or the advertisers' for example brand recognition, marketing campaign and/or timely message and/or the combination thereof. The present invention may address the providing of advertising space without these unwarranted side effects and/or may provide the dynamic advantages or the combination thereof.

### DESCRIPTION OF THE INVENTION

It is an objective of the invention to provide method and/or apparatus for intuitive virtual reality with dynamic advertisement for navigating users.

It is another objective to provide a means to advertisers to deliver effective and/or relevant advertising to end users who may travel by vehicle and/or by foot in an urban and/or suburban region and/or inside structures such as buildings private and/or public areas such as for example office building, shopping malls and/or sport areas as part of virtual navigation and/or orientation solution. The virtual advertising may or may not reflect real advertising in terms of actual representation, advertiser message and/or economic of for example “buying real-estate” for advertising in possibly both the real and/or virtual world to for example support it's branding and/or advertising campaign objectives.

To address these and other objectives, in a first aspect, the present invention may comprises a method of facilitating delivery of advertising on virtual 3D structures such as buildings private and/or public areas such as for example office building, shopping malls and/or sport areas to users of mobile computing platforms for navigation and/or orientation.

In a second aspect a virtual 3D structures such as buildings database may be provided. The virtual 3D structures database may comprise data entities that may represent features for example of buildings, such as shape, height, facades textures, and/or the like. Possibly in addition, virtual locations for displaying advertising materials may be associated with the virtual 3D structures database that may allow static and/or dynamic advertising and/or messages to be presented on and/or over the 3D structures. By ‘advertising’, a variety of media for communicating a message, such as text, images, audio, video and combination thereof are intended. Advertisers may be allowed to associate advertising messages with the advertising virtual location. Users of mobile computing platforms may be provided with navigation services that may use the virtual 3D structures datasets and/or the associated virtual advertising.

### BRIEF DESCRIPTION OF THE FIGURES

For a better understanding of the invention and/or to show how it may be carried into effect, reference will now be made, purely by way of example, to the accompanying drawings.

With specific reference now to the drawings in detail, it is stressed that the particulars shown are by way of example and/or for purposes of illustrative discussion of the embodiments of the present invention only, and/or are presented in the cause of providing what may be believed to be the most useful and/or readily understood description of the principles and/or conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic 3D perspective of a virtual urban area that could be for example also of an indoor area such for example shopping mall, office building and/or sport arena illustrating an embodiment for representing 3D structures such as for example buildings and/or 3D models signs and/or their associated advertising messages;

FIG. 2 shows the database layers that may be used to construct FIG. 1;

FIG. 3 is a diagram of the databases of FIG. 2;

FIG. 4 is a flow chat of the method that may be used to construct FIG. 1;

FIG. 5 is a block diagram of 3D virtual scenery that may be used to construct FIG. 1;

FIG. 6 is illustrates database structure, file system, and/or data flow that may be used to construct FIG. 4; and

FIG. 7 is illustrates a dynamic advertising system that may be used in 3D virtual scenery of FIG. 1;

### DESCRIPTION OF THE EMBODIMENTS

A method and/or apparatus for displaying advertising material on virtual 3D structures, define as 3D models such as buildings and/or signs to users of mobile computing platforms may be disclosed. A virtual 3D structures database may contain data entities that may represent buildings and/or models features, such as for example shape, height, facades, color, texture, and/or location. Associated with some of the data entities that may represent advertising attributes may be data that for example indicate on which of the virtual 3D structures, advertising areas that represented advertising attribute may be located, and/or its associated features such as shape and size, format, and trigger events such as for example time interval. Advertisers may be allowed to associate advertising messages from for example advertising database with said structures advertising areas. Users of mobile computing platforms may be provided with solutions and/or services on mobile platform where the mobile platform may contain a viewer 3D and/or other and/or renderer that may use the virtual 3D building database and/or associated link to advertising attribute database that may or may not display them in 3D perspective. Advertising maker, providers and/or marketer may be provided with a method and/or methods to associate an advertising message and/or messages with the structures advertising areas as well as possibly a trigger event to possibly dynamically change the advertising message. The virtual 3D scenery may or may not represent the real world; as well as the advertising messages in the virtual 3D scenery may or may not match the advertising messages in the real world. As such, the user of the mobile computing platform may be provided with the advertising message associated with the virtual 3D structures such as buildings that messages may or may not match the advertising messages in the real world to the advertising messages in the virtual 3D world.

For example, a stationary advertising on or on top of a virtual 3D structures can be identical to the actual advertising placed on the actual real 3D structures in the real world. The user may identity the structures such as building by the advertising on it and/or may gain quicker orientation. Some types of information, such as advertising, when placed on virtual 3D structures such as buildings can be more effective and/or less disruptive if it is restricted to the 3D buildings. This in compare with virtual billboard advertising placed along the travel route and/or pop-up advertizing messages in the virtual scenery that my conflict with and/or may even obscure the navigation and/or orientation information such as for example street names.

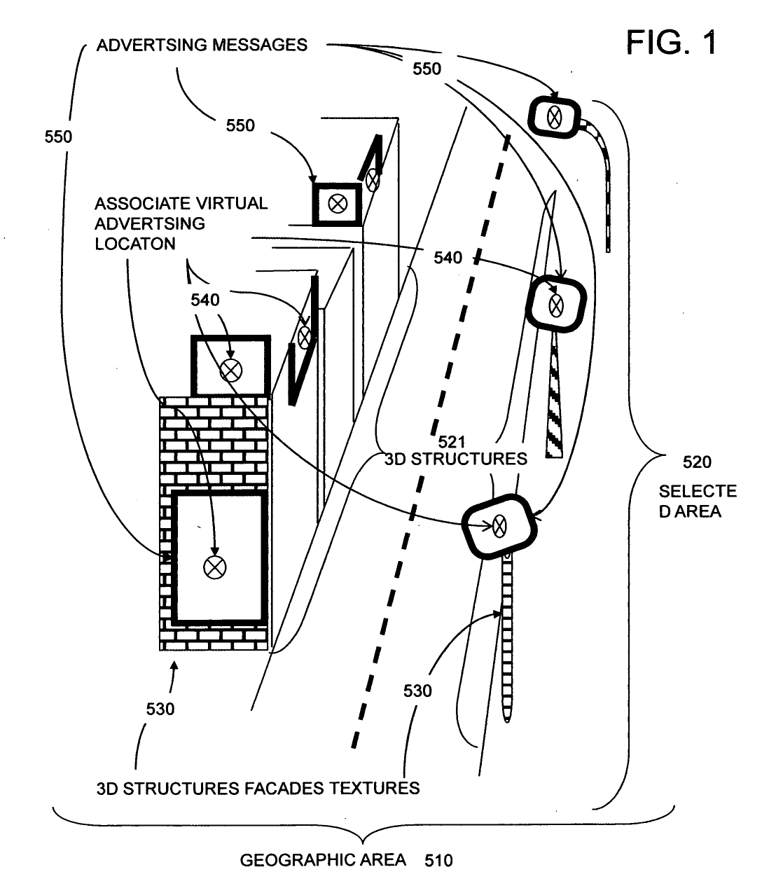

With reference now to FIG. 1, a schematic 3D perspective of the geographic area 510. In a present embodiment, the display of the urban suburban and/or in-door structures in a selected area 520 may defines a plurality of 3D structures 521 such as for example buildings within the geographic area 510. The 3D structures 521 may be defined as bounded 3D objects located within the geographic region 510. The 3D structures 521 may be all in different size, shape, and/or height. In the present embodiment the 3D structures 521 within the geographic area 510 may have a plurality of external and/or internal facade textures 530 that may be associated with any face of the 3D structure 521 and/or a plurality of external and/or internal 3D structures facades information may be associated with specific external and/or internal facade textures 530 and/or plurality of advertising messages 550 for specific geographic area 510 as possibly an urban, suburban and/or in-door building for example shopping mall and/or area is shown.

FIG. 1 may show a perspective view of the geographic area 510. In a present embodiment, the display of the urban, suburban and/or in-door structures in a selected area 520 defines a plurality of 3D structures 521 such as structures for example buildings, stores and/or arenas within the geographic area 510. The 3D structures 521 may be defined as bounded 3D objects located within the geographic region 510. The 3D structures 521 may be all in different size, shape, and/or height. In a present embodiment the 3D structures 521 within the geographic area 510 may define a plurality of facade textures 530; plurality of associate virtual advertising location 540; and/or plurality of advertising messages 550 associated with each face of the each 3D structures 521.

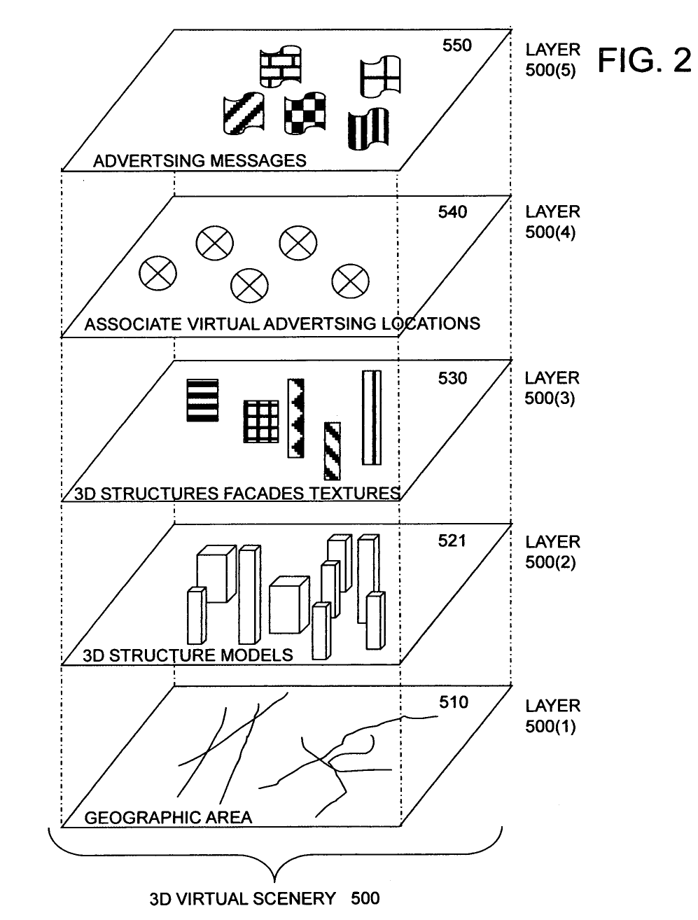

In the embodiment of FIG. 2, the 3D virtual scenery may be defined in separate layers 500(1), 500(2) . . . 500(5). Each layer may includes a separate plurality of elements that may be comprise of the illustration in FIG. 1.

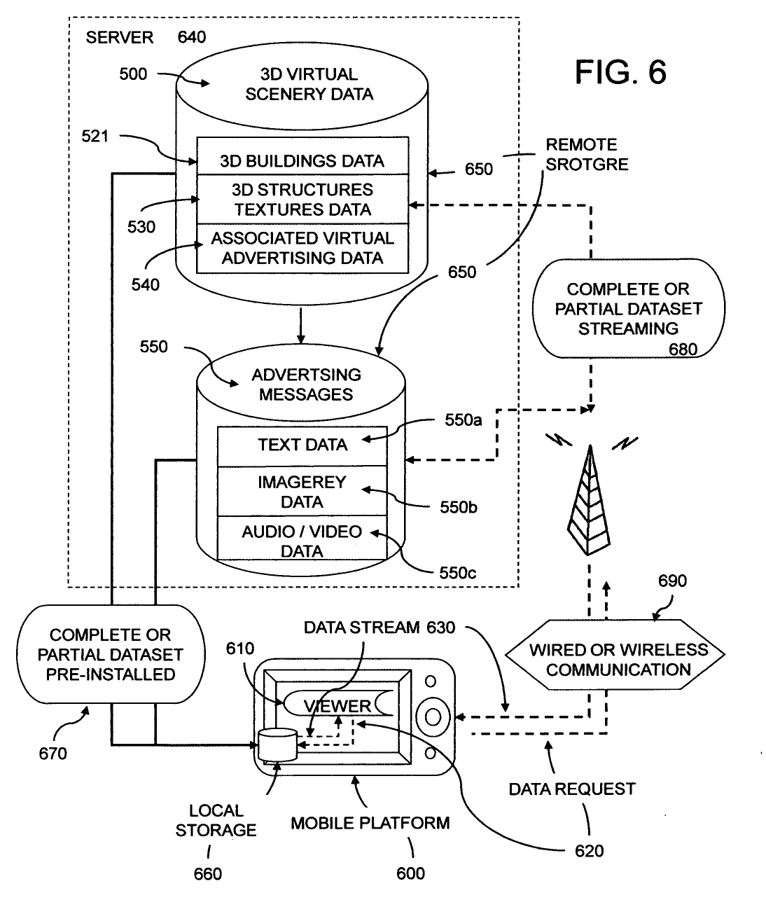

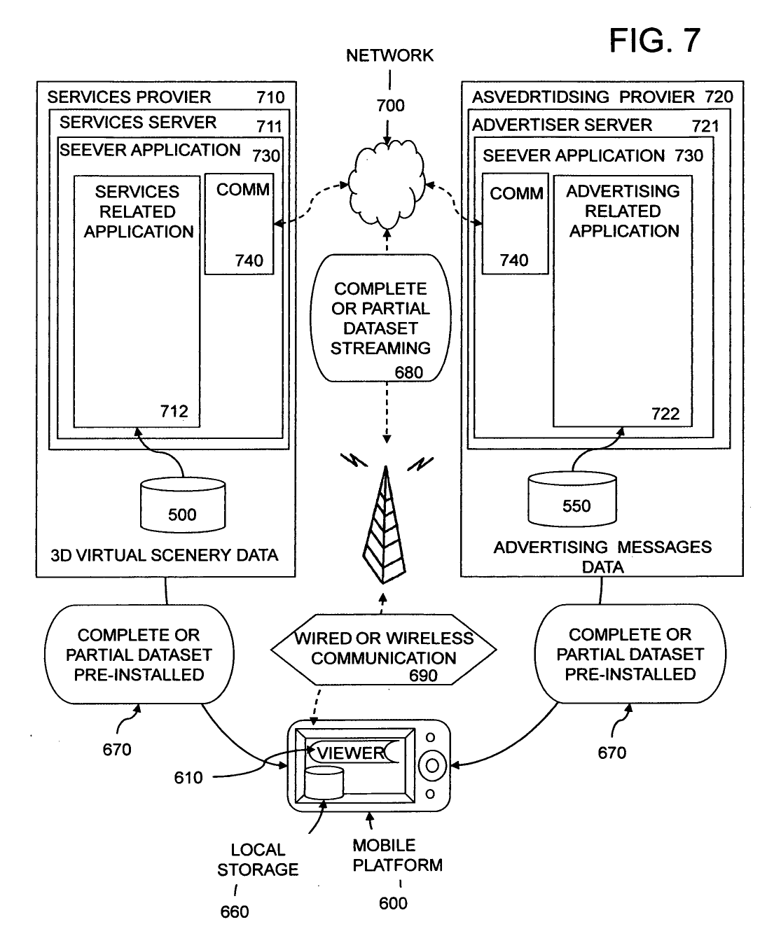

In the embodiment of FIG. 2, the layer 500(1) may be defined as a geographic area 510 as seen by the viewer 610 in FIG. 6 and FIG. 7. The layer 500(2) may be defined as the 3D structure models 521 that may be associated with layer 500(1). The layer 500(3) may be defined as the 3D structures facades textures 530 that may be associated with layer 500(2). The layer 500(4) may be defined as the associate virtual advertising locations 540 that may be associated with layer 500(3) and/or layer 500(2). The layer 500(5) may be defined as the advertising messages 550 that may be associated with layer 500(4), layer 500(3) and/or layer 500(2).

The element defined in one layer may overlap the element defined in another of the layers in completing the 3D virtual scenery. Each of the layers 500(2), 500(3) . . . 500(5) may be dependent on the immediate layer below it and may or may not be dependent on the other layers bellow the layer immediately below it. Such as for example layer 500(2) may be dependent of layer 500(1), and/or layer 500(3) may be dependent on layers 500(2) and/or may be depended of layer 500(1). Layer (500)4 may be dependent on layers 500(3) and/or may be depended of layers 500(2) and/or possibly also layer 500(1). And so on as in a present embodiment, the last layer shown 500(5) may be dependent of layer 500(4) bellow it and/or may be dependent on all or some of the lower layers bellow it 500(3), 500(2) and/or 500(1).

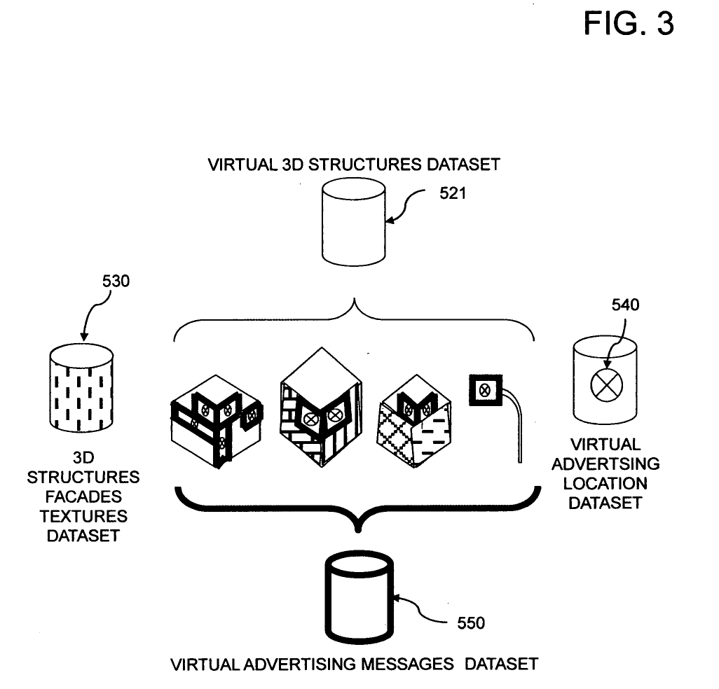

FIG. 3 may be a diagram of the databases of FIG. 2 and/or illustration of the presentation of the datasets. Multiple databases may be identified in FIG. 3, virtual 3D structures dataset 521; 3D structures facades textures 530; virtual advertising location dataset 540; and/or virtual advertising messages dataset 550. FIG. 3 may further illustrate in 3D perspective optional representation of plurality of data from the datasets. Plurality of placements of the virtual advertising locations may be on a structures texture and/or on top of the 3D structures and/or textures.

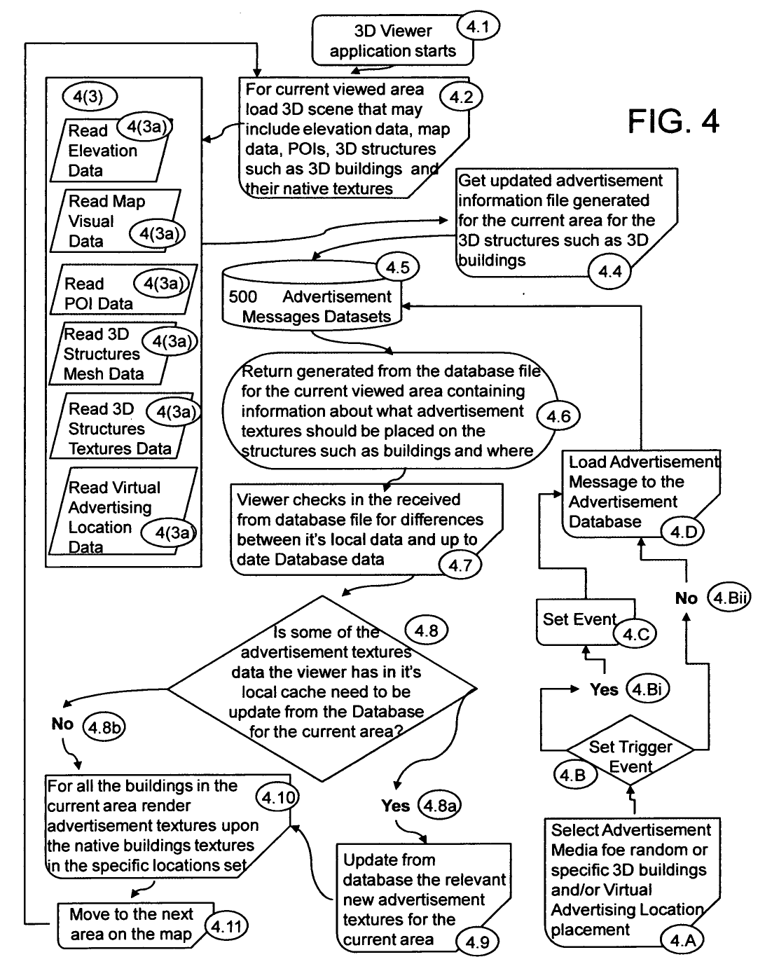

FIG. 4 may be a follow chart of the method may be used to construct a dynamic advertising on virtual 3D structures display on mobile platforms for mobile users. A viewer such as 3D viewer (610 in FIG. 6 and FIG. 7) may initiate the process 4.1. Based on possibly current camera view, including or not camera position over a geographic area, height and/or angle of view, a specific selected area based on such parameters may be read, loaded and/or rendered on for example the portable platform for mobile user 4.2. The process may read several files from local storage 660 in the mobile platform 600, and/or from remote storage-650, on remote server 640 (FIG. 6.) and/or combination thereof. This may include reading map and/or image possibly as map 4(3b); terrain elevation 4(3a); road network and/or points of interest (POIs) 4(3 c); and in a present embodiment, reading 3D structures such as buildings mass data 4(3d) for 3D structures such as buildings 521; and reading the associate 3D building facade textures 4(3e) for textures 530; and/or reading associate virtual advertising location 4(3f) for virtual location 540. Loading the 3D structures such as building virtual advertising location textures may be activating a process to read possibly part and/or all associated messages 4.4 from advertisement database 4.5.

Associate elements such as 3D structures such as 3D buildings 521, 3D structures such as building textures 530, 3D virtual advertising location 540 and/or advertising messages 550 may be associated via an ID code. Such ID code may be unique with one-to-one (1:1) relationship for example having a unique texture for a specific building facade, and/or one-to-many (1:N) where the same ID may be utilize to reflect the placement of the same texture on several facades of the same 3D structure or on plurality of deferent 3D structures facades. The same may be the case of association between a virtual advertising location 540 and/or the advertising message 550. Where the advertising message 550 may be unique to a specific virtual advertising location 540 only and/or the same advertising message may appear on plurality of virtual advertising locations. Return generated from the advertisement database file for the said current viewed area, may contain information about what advertisement textures and/or messages should be placed on which structures and/or buildings and/or where on such structures and/or buildings.

To possibly initiate, maintain and/or assure the dynamic modifications of the advertising messages displayed on the 3D buildings, at some point during and/or after partial and/or all the relevant datasets are loaded including possibly the associated advertising messages, a process 4.7 may be looking for differences between the loaded data for any change in advertising location and/or any ID indication for the associated advertising messages that may reside in the viewer cache. A determination may be made 4.8 if change exists or not. If a change may be found 4.8a a process may be activated 4.9 to update the database loaded for rendering by the viewer of the new and/or updated advertising messages. In case no change may be made 4.8b all datasets loaded may be rendered for display 4.10 by the viewer.

A change in the viewed geographic area 510 may trigger a process 4.11 that may initiate the repeat of the entire and/or partial processes 4.1 through 4.10 as described above.

A possible separate but possibly related process may be controlled and/or initiated by the advertising messages maker and/or marketers that oversee the selection of advertising messages and/or their virtual location placement. A process may be initiated to select advertising messages 4.A and/or associated the selected advertising message 550 with a virtual advertising location 540. This my be as a one-to-one (1:1) relation where one advertising message match only one specific virtual advertising location or one-to-many (1:N) relation where a single advertising message my be selected to be displayed on multiple virtual advertising locations in the selected area 520 in FIG. 1. The matching between the advertising message and the virtual advertising location may be done via IDs that matches that of the 3D structures and/or building datasets. Once possibly the advertising message and/or its virtual advertising location are selected a process may determine if a trigger event should be activated and/or associated with each advertising message and/or its related virtual advertising location 4.B. In case an event may be desired 4.Bi a process may be set to add the trigger event 4.C. Such event may be based on for example a counter for possible time such as calendar time, specific time the scene is viewed continuously by a single viewer and/or accumulative number of times views by a single viewer; accumulative time viewed by multiple viewers along a calendar time and/or cumulative number of viewer, such as unique visitors and/or viewers, and/or the combinations thereof that may serve as a trigger event to change the advertising message associated with that associated virtual location and/or locations. In case for example that no trigger event may be desired 4.Bii and/or possibly after the completion of setting the trigger event and/or events, the information is then loaded 4.D to the advertising messages database 550.

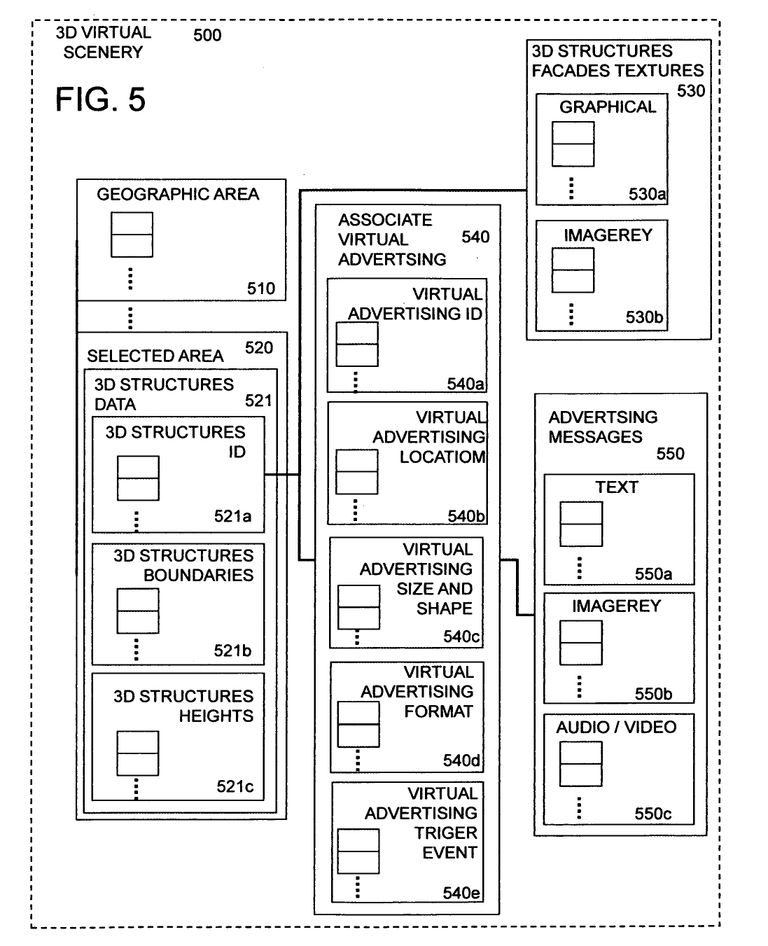

FIG. 5 is a block diagram of database structure and/or file system of FIG. 3, and FIG. 4. The block diagram may illustrates the database structure and/or file system of 3D virtual scenery 500. The 3D virtual scenery may be comprised of plurality of geographic areas 510. Each geographic area may have a unique selected area 520, whereby a plurality of 3D structures and/or 3D building data 521 that may be associated with such selected area. The 3D structures data may represent the actual 3D structures and/or buildings in the said selected area. The 3D structures data may comprised of a) plurality of 3D structures ID 521a that may be relating to a specific structure and/or building; b) plurality of 3D structures boundaries 521b that may represent the shape of the building as a collection of plurality of connected line segments to a for example polygon, as may be viewed from the top at a 90 degree angle; and/or c) plurality of 3D structure and/or building height 521c as be may associate to the line segments of the 3D structure boundary.

The 3D structures ID 521a may be referenced 3D facades structures and/or building textures 530, and/or associated virtual advertising area 540. A single 3D structure ID may reference plurality of 3D facades structures textures 530, and/or plurality of associated virtual advertising area 540. The 3D facades structures textures may include plurality of graphical textures 530a and/or imagery textures 530b. The 3D structures ID may include ID facades information for said 3D structures specific facades. Such facades ID may be based on possible plurality of sub-ID in the 3D structures ID and/or the facades ID information will be included in the 3D structures ID string that may reference each and/or every of said 3D structures facades. The 3D structures textures may be the same texture for plurality of facades in said 3D structures and/or plurality of building and/or they may include graphical, imagery and/or combination thereof of said structures textures.

The Associated virtual advertising data 540 may contain plurality of a) virtual advertising ID 540a, b) virtual advertising location 540b, c) virtual advertising properties such as size and shape 540c, d) virtual advertising format 540d, and/or e) virtual advertising trigger event 540e. Said elements 540a to 540e may have one-to-one (1:1) and/or one-to-many (1:N) relationships.

The advertising messages 550 may be associated to the virtual advertising 540 via one or several of the virtual advertising elements 540a to 540e. Whereby, for example the advertising message may be associated to the 3D structures texture facade via one of the virtual advertising ID, location, size and/or shape, format, target event and/or the combination thereof. The advertising message data 550 may contain text 550a; imagery 550b, and/or audio/video 550c and/or the combination thereof.

FIG. 6 illustrates a possible system for supporting the database structure of FIG. 5. A server 640, whether single or plurality of servers whether local and/or remote and/or combination thereof, may contain a plurality of remote storage device 650. Each said remote storage device 650 may contain the 3D virtual scenery data 500 and/or virtual advertising messages 550. The 3D virtual scenery data 500 may contain a) 3D structures data 521, b) 3D structures texture data 530, and/or c) associated virtual advertising data 540 on one or plurality of storage devices in said servers 640. The advertising messages data 550 may contain a) text data 550a, b) imagery data 550b, and/or c) audio/video data 550c on one or plurality of storage devices in said servers 640.

Data from 3D virtual scenery data 500 and/or virtual advertising messages 550 for a pre selected geographic area 510 completely or partially may be preinstalled 670 on a local storage 660 whether side storage may be fix storage and/or removal on the mobile platform 600. Alternately to or in combination thereof 670, data from 3D virtual scenery data 500 and/or virtual advertising messages 550 for a pre selected geographic area 510 completely and/or partial may be streamed 680 via wire and/or wireless communication 690 and/or combination thereof. The request for local and/or remote steaming and/or combination thereof, may be done by the viewer 610 in the portable platform 600. The viewer 610 may send data requests 620 possibly for example based on said viewer position such as 3D perspective, angle, height and/or orientation over the geographic area 510 to said server 640, and/or local storage 660 and/or combination thereof, and may receive data steam 630 of 3D virtual scenery data 500 and/or advertising messages 550 to present the selected area 520. Any possible change in the viewer position may trigger a new data request 620 that may be followed by a new data stream 630.

FIG. 7 illustrates a possible dynamic advertising system that may be used in 3D virtual scenery of FIG. 1. The system comprised of a services provider 710 and/or advertising provider 720. Whereby the services provider may utilize a services server 711 and/or the advertising provider may utilize an advertiser server 721. Said services server 711 and/or advertiser server 721 may utilize server application 730 to possibly operate said servers. A related services application 712 may be controlled by said server application 730 for the services provider 710 that may be connected to 3D virtual scenery data 500, and/or advertising related application 722 may be controlled by said server application 730 for the advertising provider 720 that may be connected to advertising messages data 550. The server application 730 may also control a communication application 740 that may be connected each said server and/or services to the Network 700 (e.g., local area network, wireless network, Network, intranet, etc.).

Complete or partial dataset 670 of 3D virtual scenery data 500 and/or advertising messages data 550 may be stored on local storage 660 in the mobile platform 600 to be display on the mobile platform via possibly the viewer 610. Alternately to or in combination thereof 670, data from 3D virtual scenery data 500 and/or virtual advertising messages 550 for a pre selected geographic area 510 completely and/or partial may be streamed 680 via wire and/or wireless communication 690 and/or combination thereof.

Thus the scope of the present invention may be defined by the appended claims and/or includes both combinations and/or sub combinations of the various features described hereinabove as well as possibly variations and/or modifications thereof, which may occur to persons skilled in the art upon reading the foregoing description.

In the claims, the word “comprise”, and/or variations thereof such as “comprises”, “comprising” and/or the like indicate that the components listed may included, but not generally to the exclusion of other components.

1. A method and/or apparatus of facilitating delivery of advertising on virtual 3D structures may be define as 3D models such as buildings and/or 3D signs to users of mobile computing platforms that may be comprising of: virtual 3D structures database, wherein a virtual 3D structures such as building database that may include the 3D models, shape, height, with or without texture, facades and/or location and/or further, wherein some of the 3D buildings in a virtual 3D structures database; may be providing a virtual advertising location, said virtual advertising location may represents an area located on, and/or on top, and/or in that virtual 3D structure, said virtual advertising location data may be comprising of data that may indicates in addition for example in which of said advertising database the advertising attributes may be located; associating advertising messages with of said virtual 3D buildings; and/or storing said advertising messages in an advertising database.

2. The method of claim 1 further comprising: possible defining an index that may references each of the virtual 3D buildings with each of their virtual advertising location.

3. The method of claim 1 wherein said virtual 3D structures, 3D buildings and/or 3D models may be formed dynamically.

4. The method of claim 1 wherein said virtual advertising may be formed dynamically.

5. The method of claim 4 further comprising: possible defining an index that may trigger the dynamic change of said virtual advertising.

6. A method of facilitating delivery of advertising to users of virtual 3D buildings data may be comprising the steps of:
(a) defining a plurality of virtual 3D structures such as buildings, and/or
(b) defining a hierarchy of a virtual advertising location,
wherein a hierarchy of virtual advertising location may includes a possible virtual location associated with the virtual 3D structures, and/or further may, wherein some of the virtual advertising location may provides a database that may contains size, shape, format, and/or data that may indicate which of said virtual advertising location may be linked to said advertising database.

7. The method of claim 6 further comprising: possible defining an index that may reference the virtual 3D structures to the virtual advertising location.

8. The method of claim 6 further comprising: possible defining an index that may references the virtual advertising location to the advertising database.

9. The method of claim 6 wherein said virtual 3D structures such as buildings display may be based on viewer such as possibly 3D viewer visibility.

10. The method of claim 6 wherein said advertising database may provide index that may references for example advertising size, shape, format, time for display, number of unique viewers, viewer's profile, expiration date, maker, owner, and/or billing information and/or the combination thereof.

11. A database stored on a computing device for example readable medium comprising: virtual 3D structures attributes data that may represent shape, height and/or facades textures; and/or virtual advertising location data that may indicate which of a plurality of advertising messages into which the advertising messages may be located in which server location, wherein said virtual advertising location may define a hierarchy that may include virtual location, and/or further, wherein some of the advertising attributes may be stored in said database; and/or advertising messages data that may represent advertising attributes such as for example size, shape, and/or format possibly including media of one and/or combination of text, image, audio, and/or video and/or combination thereof.

12. The invention of claim 11 wherein said virtual 3D structures such as buildings database may further comprises: an index that may reference virtual advertising location that may encompass other virtual advertising location and/or locations.

13. The invention of claim 11 wherein said databases; virtual 3D structures, virtual advertising location database and/or advertising database, may be installed in for example a standalone mobile computing system, reflecting an offline solution.

14. The invention of claim 11 wherein said databases; virtual 3D structures, virtual advertising location database and/or advertising database, may be installed on a possible singular and/or plurality of remote servers that may be obtained by the user from for example a standalone mobile computing system, reflecting an online solution.

15. The invention of claim 11 wherein said databases; virtual 3D buildings, virtual advertising location database and/or advertising database where some datasets may be installed in for example a standalone mobile computing system and/or others on a possible singular and/or plurality of remote servers that may be obtained by the user from for example a standalone mobile computing system, reflecting hybrid solution.

16. The invention of claim 11 wherein said virtual advertising locations data may includes an indication of which of a singular and/or plurality of advertising messages, a particular advertising message may be located in.
